(19) United States
(12) Patent Application Publication
(10) Pub. No.: US 2024/0305237 A1
(43) Pub. Date: Sep. 12, 2024

(54) WIRE ROPE-BASED RACKING SYSTEM

(71) Applicant: Learner Lab IP Holdings LLC, Oakland, CA (US)

(72) Inventor: Adam Larner, Oakland, CA (US)

(21) Appl. No.: 18/182,064

(22) Filed: Mar. 10, 2023

(51) Int. Cl. H02S 20/20; E04H 12/20

(52) U.S. Cl. CPC H02S 20/20; E04H 12/20; G02B 26/0816

(57) ABSTRACT

Embodiments are disclosed for a wire rope-based panel racking system. In some embodiments, the wire rope-based panel racking system is a solar tracker comprising at least one panel, a foundation including at least two posts, and a wire rope network coupled to the foundation between the at least two posts, the wire rope network comprising a plurality of wire ropes structurally supporting the at least one panel, wherein the wire rope network lacks a rigid frame.

### BACKGROUND

Racking systems provide structural support for various renewable energy sources. For example, racking systems are used to support photovoltaic panels (e.g., solar panels) to convert solar energy into electricity. Likewise, solar thermal energy uses mirrored panels, supported by racking systems, to concentrate and convert solar heat energy into electricity. Conventional racking systems are made of aluminum extrusions, steel beams, and other rigid metal framing components.

### SUMMARY

Embodiments are disclosed for a wire rope-based panel racking system. In some embodiments, the wire rope-based panel racking system is a solar tracker comprising at least one panel, a foundation including at least two posts, and a wire rope network coupled to the foundation between the at least two posts, the wire rope network comprising a plurality of wire ropes structurally supporting the at least one panel, wherein the wire rope network lacks a rigid frame.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a single axis tracker racking system;

FIG. 2 illustrates a diagram of a fixed axis tracker racking system;

FIG. 3 illustrates a diagram of a single axis tracker wire rope-based racking system in accordance with one or more embodiments;

FIG. 4 illustrates an overhead view of a wire rope-based racking system in accordance with one or more embodiments;

FIG. 5 illustrates a rear view of a single axis tracker wire rope-based racking system installed on a site in accordance with one or more embodiments;

FIG. 6 illustrates a rear view of a single axis tracker wire rope-based racking system installed on a site in accordance with one or more embodiments;

FIGS. 7-9 illustrate additional views of a single axis tracker wire rope-based racking system in accordance with one or more embodiments;

FIG. 10 illustrates an example site deployment of a single axis tracker wire rope-based racking system in accordance with one or more embodiments;

FIG. 11 illustrates a rear view of an example site deployment of a single axis tracker wire rope-based racking system in accordance with one or more embodiments;

FIG. 12 illustrates additional views of a single axis tracker wire rope-based racking system in accordance with one or more embodiments;

FIGS. 13-16 illustrate additional views of a fixed axis wire rope-based racking system in accordance with one or more embodiments;

FIG. 17 illustrates an example site deployment 1700 of a fixed wire rope-based racking system in accordance with one or more embodiments;

FIG. 18 illustrates examples of wire rope attachment systems in accordance with one or more embodiments;

FIGS. 19-20 illustrate wire rope arrangements in accordance with one or more embodiments; and

FIGS. 21-23 illustrate examples of wire rope-to-panel mounts in accordance with one or more embodiments.

### DETAILED DESCRIPTION

In the detailed description, embodiments have been described with reference to specific exemplary embodiments thereof. The various embodiments described herein are also described with respect to the accompanying drawings. The description herein and drawings are illustrative of one or more embodiments and are not to be construed as limiting. Numerous specific details are described to provide a thorough understanding of various embodiments.

One or more embodiments of the present disclosure include a wire rope-based racking system. As discussed, conventional racking systems are constructed of rigid metal members, which form a frame that structurally supports panels (e.g., photovoltaic panels, mirrored panels, etc.) for use in renewable energy generation. Such racking systems may be fixed, where the panels are permanently installed in a particular position, or may include a tracking system, where the panels may be maneuvered on one or more axes based on the relative position of the Sun.

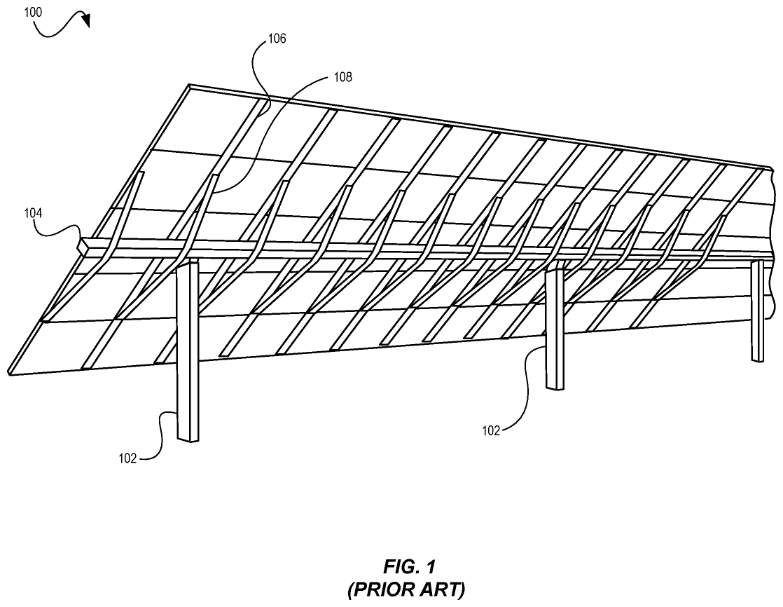

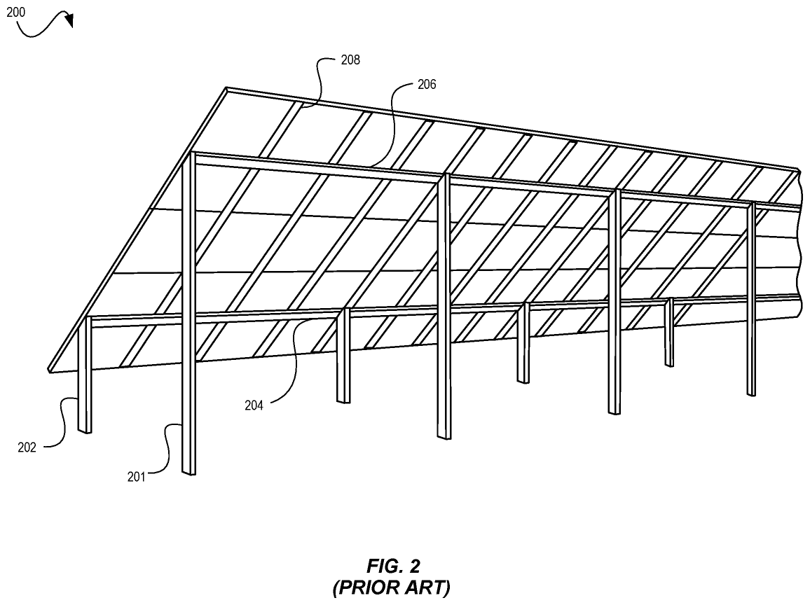

For example, FIG. 1 illustrates a diagram of a single axis tracker racking system 100. Such conventional systems include foundations 102 which secure the racking system to the site (e.g., via piers, pilings, etc.). In the example of FIG. 1, the single axis tracker is implemented as a rigid crossmember 104. The panels are supported by a frame constructed from metal supports 106 and 108 which is mounted to the crossmember 104. The crossmember is driven by a tracker mechanism which may form the connection between the crossmember and the foundations. FIG. 2 illustrates a diagram of a fixed axis tracker racking system 200. In the example of FIG. 2, the racking system 200 includes multiple foundations 201 and 202 to which a rigid metal frame is attached. The rigid metal frame is formed from two crossmembers 204 and 206 along with vertical supports 208. The panels are then mounted to this frame. Unlike the single axis tracker racking system of FIG. 1, the panels of racking system 200 remain in their fixed position throughout the life of the installation.

While such conventional racking systems are effective at both small-scale installations (e.g., home installations) and large-scale installations (e.g., utility-level installations), they are not without costs. For example, the rigid metal components are heavy, which adds transportation costs as well the energy required in their manufacture. Additionally, rigid metal components, by their nature, offer limited flexibility, which requires installations to be made with minimal angular deviation. As such, site preparation costs are significant for large scale installations, where the ground must be flattened over hundreds or thousands of acres to accommodate the installation requirements of such conventional racking systems. The site preparation costs include not only the literal construction costs but also the environmental costs of large-scale soil disturbance, which disrupts habitats and releases otherwise sequestered greenhouse gases back into the atmosphere.

To address these and other deficiencies in conventional racking systems, embodiments replace much of the rigid metal structural supports with wire ropes and/or cables. For example, in some embodiments, a racking system includes a pair of foundations. These foundations may include one or more of piers, screwed or driven piles, anchors, ballasts, etc., depending on application and site needs. Additionally, the use of wire ropes in place of rigid metal frames significantly reduces the amount of material needed to construct a racking system. Spools of cable or wire rope can be transported more efficiently to and from installation sites. Further, the reduced weight of the cables versus the rigid frames allows for fewer foundations to be used for the same length of racking system.

Wire rope-based racking systems also provide other installation benefits. Because of the flexibility of the wire ropes, as compared to the rigid frames of conventional systems, the installation site does not have to be flat. This greatly reduces the site preparation and disturbance to the soil. This helps preserve native habitats and keeps soil carbon undisturbed.

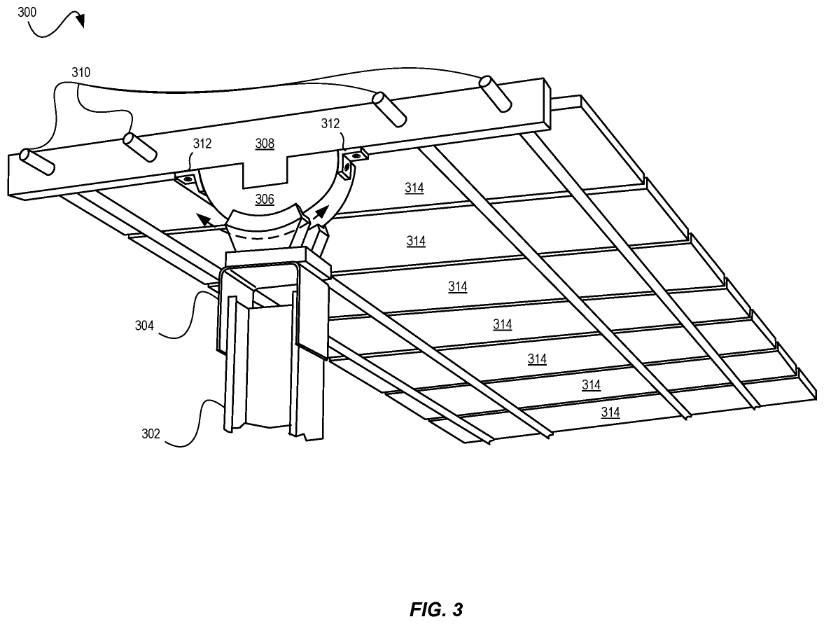

FIG. 3 illustrates a diagram of a single axis tracker wire rope-based racking system 300 in accordance with one or more embodiments. As shown in FIG. 3, the wire rope-based racking system 300 can use foundations 302 and tracking mechanisms 304, 306 from conventional systems. For example, the tracking mechanism 306 is mounted to the foundation via tracker bracket 304 as in conventional systems. The tracking mechanism 306 is designed to hold a crossmember (such as crossmember 104). The tracker mechanism then rotates in the illustrated direction to rotate the panels along the long axis of the crossmember. However, in the embodiment of FIG. 3, the crossmember has been replaced by a wire rope bracket 308 and a plurality of wire ropes 310.

In some embodiments, wire rope bracket 308 is designed to fit into the slot of the tracker mechanism that previously housed the crossmember. Additionally, or alternatively, the wire rope bracket may be fixedly coupled to the tracker mechanism via a flange, bracket, or other connector, such as flanges 312. In this example, the flanges are mechanically coupled to the bracket 308 and the tracking mechanism 306 using screws or other fasteners. Alternatively, the bracket may be welded, clamped, riveted, epoxied, or otherwise joined.

As shown in FIG. 3, the panels 314 are supported by the wire rope network. Although in this example, the wire rope network comprises four parallel wire ropes, in some embodiments the wire rope network may include more or fewer wire ropes depending on environmental, layout, or other installation-specific considerations. For example, the leading-edge row of panels that absorb direct wind impact, snow load, etc., may include more wire ropes while centrally located rows that are sheltered by other rows of panels or other environmental obstructions may include fewer wire ropes.

As shown, in some embodiments, the racking system includes at least one panel, a foundation including at least two posts, and a wire rope network coupled to the foundation between the at least two posts. The wire rope network comprises a plurality of wire ropes structurally supporting the at least one panel, wherein the wire rope network lacks a rigid frame. As shown in FIG. 3, the panel(s) (e.g., solar or other photovoltaic panel, mirror, etc.) are coupled to the wire rope network. Thus, without the use of a separate rigid frame, the wire rope network itself supports the panel(s). In some embodiments, the panel(s) are coupled to each wire rope of the plurality of wire ropes using a wire rope strap.

In some embodiments, the wire rope network includes a first wire rope bracket, wherein a first end of the plurality of wire ropes is connected to the first wire rope bracket, and a second wire rope bracket, wherein a second end of the plurality of wire ropes is connected to the second wire rope bracket. The first wire rope bracket is coupled to a first post of the foundation at a fixed angle and the second wire rope bracket is coupled to a second post of the foundation at the fixed angle. In some embodiments, the wire rope network further includes one or more cross cables connecting the wire ropes to one another.

In some embodiments, the wire rope network further includes a first wire rope bracket, wherein a first end of the plurality of wire ropes is connected to the first wire rope bracket, and a second wire rope bracket, wherein a second end of the plurality of wire ropes is connected to the second wire rope bracket. The first wire rope bracket is coupled to solar tracking mechanism, wherein the solar tracking mechanism is coupled to a first post of the foundation. In some embodiments, the second wire rope bracket is coupled to a second solar tracking mechanism coupled to a second post of the foundation. In some embodiments, the solar tracking mechanism is a single axis tracker.

In some embodiments, the posts of the foundation are buried. Alternatively, in some embodiments, the foundation is ballasted. As discussed, the flexibility inherent in the wire rope network allows for a greater slope to exist between posts than in convention systems. For example, in some embodiments, a slope between a first post of the foundation and a second post of the foundation does not exceed 35 degrees.

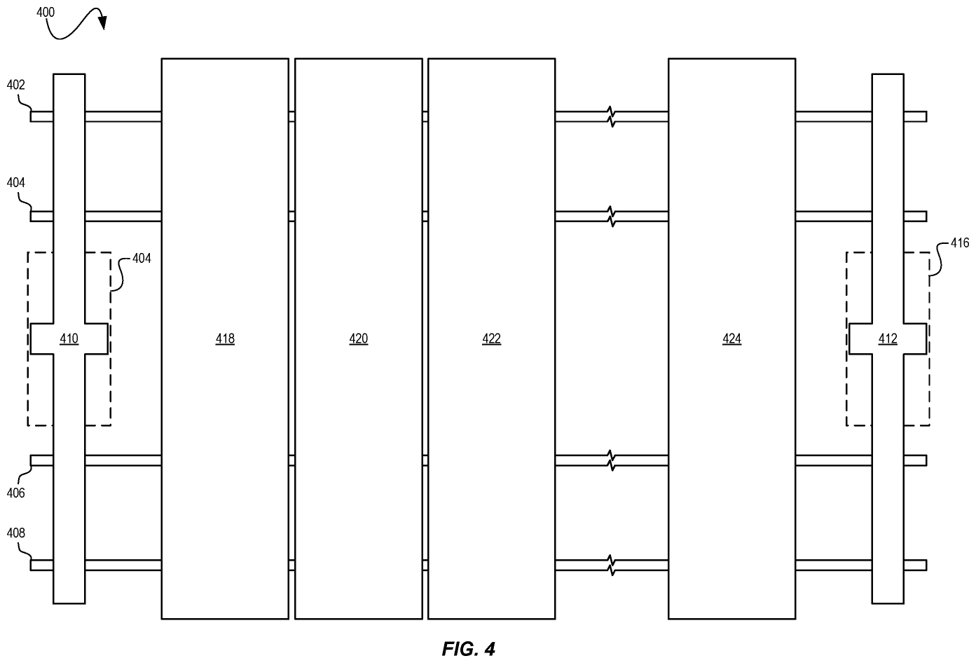

FIG. 4 illustrates an overhead view of a wire rope-based racking system 400 in accordance with one or more embodiments. As shown in FIG. 4, the wire rope-based racking system structurally supports a plurality of panels using wire ropes, without the use of a rigid frame as shown in conventional systems, described above. In particular, the wire rope-based racking system includes a wire rope network coupled to a pair of wire rope brackets. In the example of FIG. 4, the wire rope network includes four wire ropes 402-408 which are connected to wire rope brackets 410 and 412. The wire rope brackets 410 and 412 may be made from metal bars or beams (e.g., steel, extruded aluminum, or other structural metals as are known in the art).

As discussed further below, the wire rope brackets 410 and 412 that are used in any given installation may vary depending, e.g., on the type of foundation in use, type of tracking mechanism (if installed in a tracker installation), etc. For example, in FIG. 4, the wire rope brackets 410, 412 are designed to be mounted to a specific tracking mechanism 404, 416 (e.g., tracking mechanism 306 from FIG. 3). However, in various embodiments, the wire rope-based racking system may be mounted to different tracking mechanisms and the brackets may be modified to mount to those specific tracking mechanisms. The wire rope bracket 410, 412 may be designed to be coupled to the particular tracker mechanism in use or may be joined to the tracker mechanism using fasteners, welds, etc. Additionally, or alternatively, the wire rope-based racking system may be used in a fixed installation. In such instances, the wire rope brackets may be mounted to the foundation, either directly or via another mounting bracket, depending on foundation type or other installation-specific requirements.

The wire ropes 402-408 may be coupled to the wire rope bracket using various conventional techniques. For example, the wire rope bracket may include one or more eyelets through which the wire rope is passed before being crimped or connected via rope clips, passed through the bracket and fixed to the other side, etc. As discussed further below, the panels 418-424 may then be connected to the wire ropes. For example, a wire rope clip, tie, or similar may be looped around the wire rope and fastened to the panel using one or more fasteners. Although FIG. 4 depicts two large panels, in some embodiments, panels 418-424 each represent multiple smaller panels.

The overall length of the wire rope-based racking system 400 may vary depending on installation. For example, a fixed-angle system may be longer between foundations than a single axis tracker system. Similarly, the length may be chosen based on environmental factors and site placement. For example, the edges of an installation that are exposed to greater weather-related stress may use shorter wire rope-based racking systems versus interior locations that are more sheltered. Additionally, although the example wire rope-based racking system 400 of FIG. 4 includes four panels, any given implementation may have more or fewer panels.

In some embodiments, a panel racking system includes a wire rope-based racking system comprising a plurality of wire rope brackets coupled to one another using a plurality of parallel wire ropes. For example, in FIG. 4, the wire rope network includes wire rope brackets 410 and 412, which are connected via four wire ropes 402-408. Although four wire ropes are used in the example of FIG. 4, a wire rope network may include two or more wire ropes. The panel racking system also includes a plurality of foundation posts, wherein each wire rope bracket is mounted to a foundation post. For example, each wire rope bracket 410, 412 are mounted to foundation posts, such as post 302 of FIG. 3. The panel racking system also includes a plurality of panels, wherein each panel is coupled to the plurality of wire ropes using a plurality of wire rope-to-panel mounts.

In some embodiments, the plurality of panels includes at least one heliostat. In some embodiments, the wire rope-to-panel mount is attached to a panel using a fastener, wherein as the fastener is tightened the wire rope-to-panel mount is compressed around the wire rope. In some embodiments, a grade between a first foundation post and a second foundation post does not exceed+/−35 degrees.

In some embodiments, a wire rope-based racking system includes a wire rope network including a plurality of wire ropes, the wire rope network supporting at least one panel that is mounted to the wire rope network, a first wire rope bracket coupled to a first end of the wire rope network, and a second wire rope bracket coupled to a second end of the wire rope network. The first wire rope bracket and the second wire rope bracket are coupled to a foundation. In some embodiments, and as discussed further herein, the first wire rope bracket and the second wire rope bracket are coupled to a foundation at a fixed angle. In some embodiments, the first wire rope bracket is coupled to the foundation via a first tracking mechanism and wherein the second wire rope bracket is coupled to the foundation via a second tracking mechanism.

In some embodiments, the foundation comprises a first post coupled to the first wire rope bracket and a second post coupled to the second wire rope bracket. In some embodiments, the wire rope-based racking system also includes a plurality of panels, including the at least one panel, wherein the plurality of panels are mounted to, and supported by, the wire rope network.

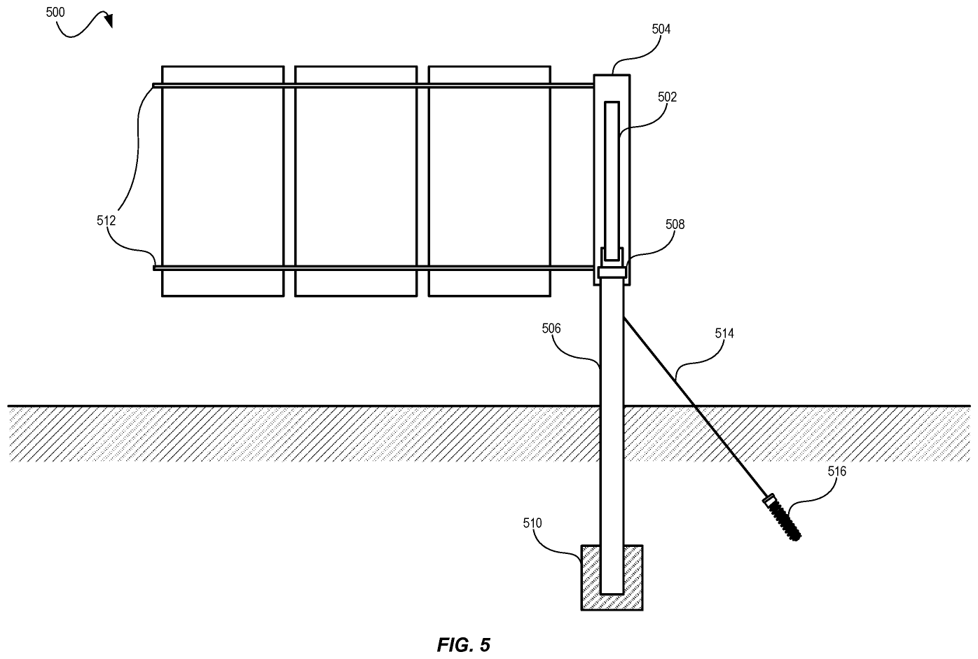

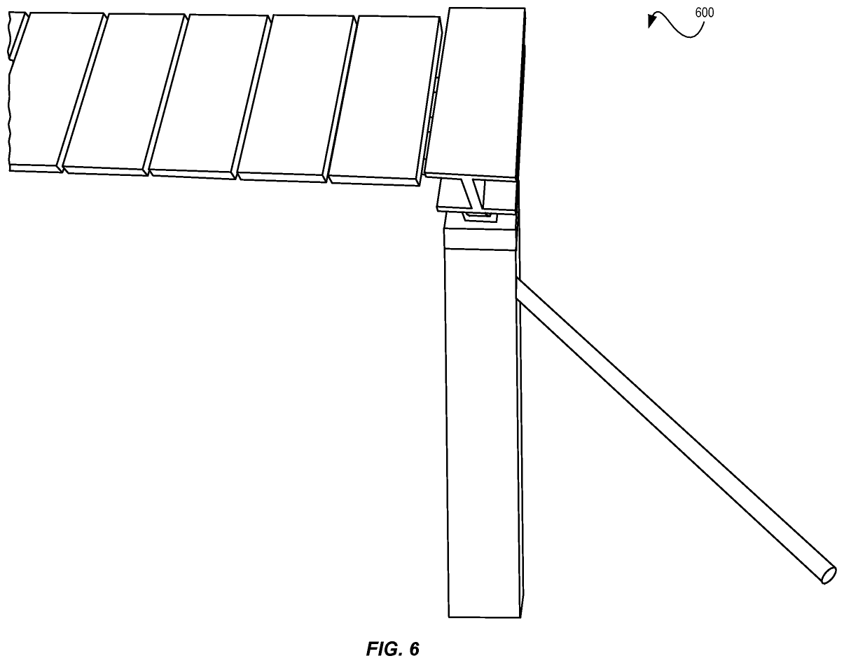

FIG. 5 illustrates a rear view 500 of a single axis tracker wire rope-based racking system installed on a site in accordance with one or more embodiments. As shown in FIG. 5, the single axis tracker wire rope-based racking system is attached to tracker mechanism 502 via bracket 504. In some embodiments, the tracker mechanism 502 in use is mounted to a foundation 506 via a tracker bracket 508. The tracker may be integral to the foundation and/or the tracker mechanism may be bolted or otherwise fastened directly to the foundation. In the example of FIG. 5, the foundation 506 is a post set in concrete 510, however other foundations may be used depending on site conditions, intended use, etc. FIG. 6 shows a front view 600 of a similar installation to that depicted in FIG. 5

In this example, the wire rope-based racking system includes two wire ropes 512 supporting a plurality of panels. These wire ropes end up transferring greater loads to the foundations as they flex and sway in place as compared to traditional rigid structures. As such, in various embodiments, each foundation is stabilized using a guy wire 514. The exact placement, angle, tension, etc. of the guy wire will vary depending on installation which may be determined using known site design techniques. The guy wire may be secured into the ground via a ground anchor 516 or other tie down.

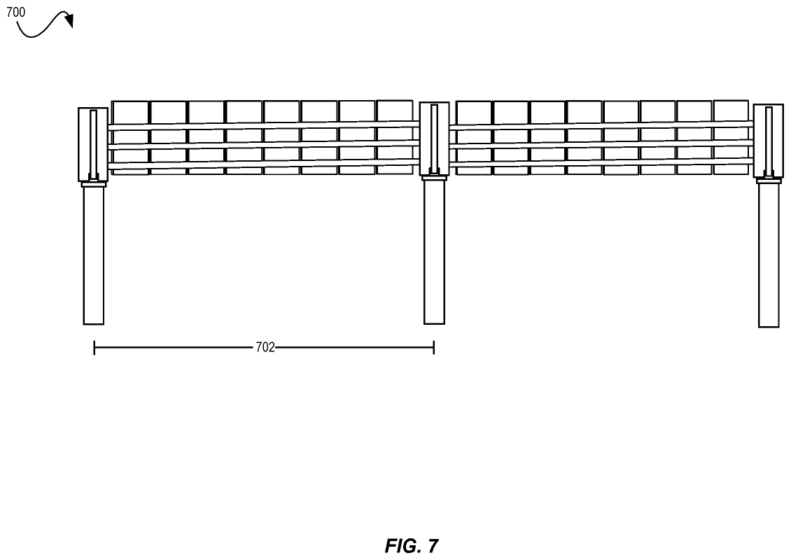

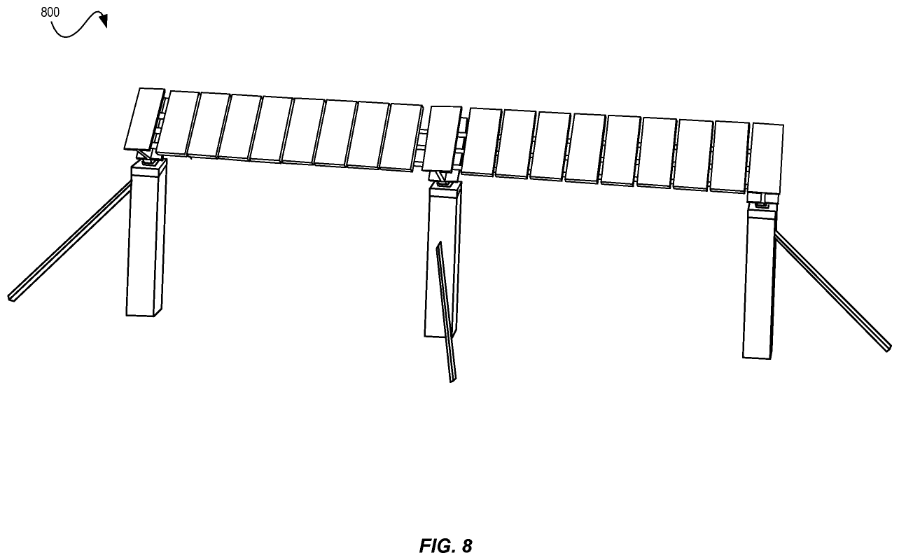

FIGS. 7-9 illustrate additional views of a single axis tracker wire rope-based racking system in accordance with one or more embodiments. As shown in FIG. 7, a row 700 of panels can be constructed from multiple wire rope-based racking systems connected to multiple foundations. As noted, the distance 702 between foundations may vary from installation to installation based on, e.g., terrain, climate, etc. Although two wire rope-based racking systems connected via three foundations is shown in FIG. 7, in various embodiments the row may include more or fewer wire rope-based racking systems depending on installation requirements. FIG. 8 shows a front view 800 of the installation of FIG. 7. As discussed, each foundation is stabilized with a guy wire. Each guy wire may be connected to each foundation using known techniques.

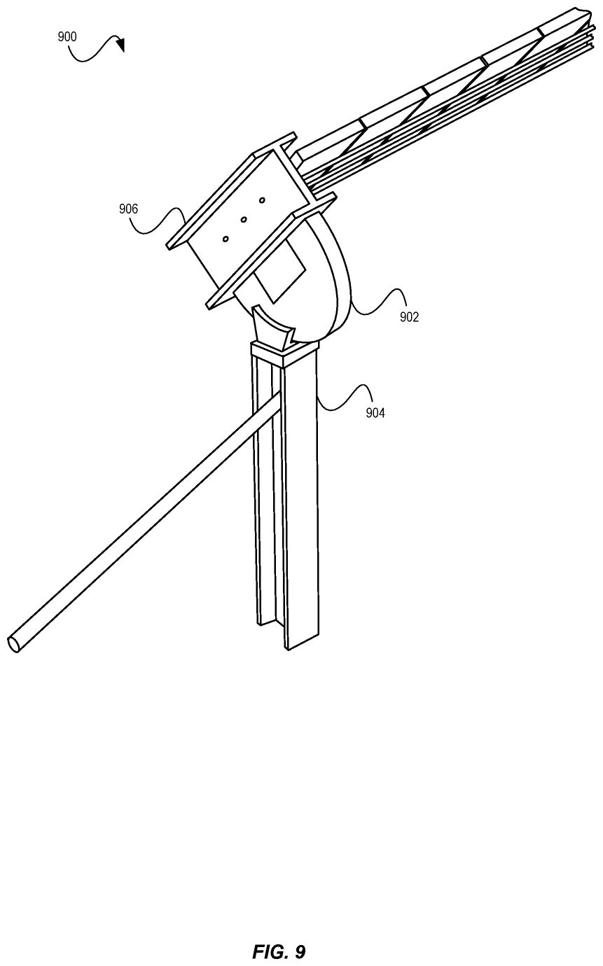

FIG. 9 shows an isometric view 900 of the single axis tracker wire rope-based racking system. As discussed, a tracker mechanism 902 is coupled to a foundation 904. This allows for the wire rope-based racking system to be rotated along an axis allowing the sun to be tracked through the day. The wire rope-based racking system is connected to the tracker via wire rope bracket 906. As discussed, the wire rope-based racking system includes wire ropes connected to a pair of wire rope brackets.

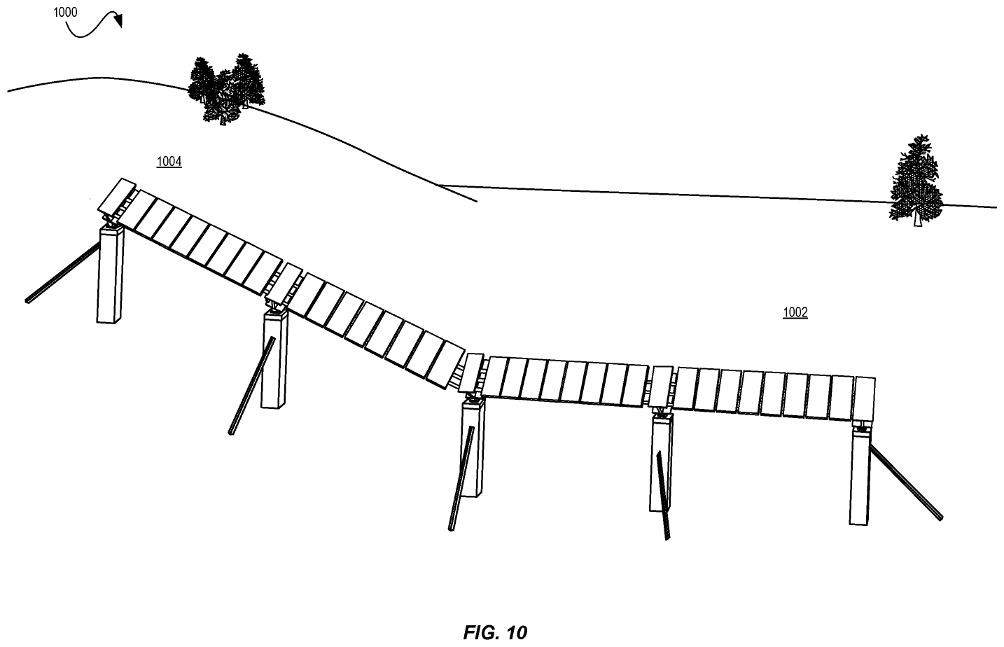

FIG. 10 illustrates an example site deployment 1000 of a single axis tracker wire rope-based racking system in accordance with one or more embodiments. As discussed, conventional racking systems require a significant amount of site preparation. In particular, the site must be substantially leveled, as there is a limit to the grade over which the rigid frames of traditional systems may be installed. However, as shown in FIG. 10, embodiments may be installed with minimal site preparation. In the example of FIG. 10, the site includes a flat area and a hilly area. Conventional systems would either limit the area over which the system may be installed, or would require significant earth moving operations to level the hilly area 1004. However, the use of wire ropes provides increased installation flexibility. In particular, the maximum grade between a pair of foundations can be 35 degrees. This enables coverage over rough terrain with minimal site preparation. Instead, planners can evaluate a site to determine a number of foundations to be placed to achieve maximum coverage.

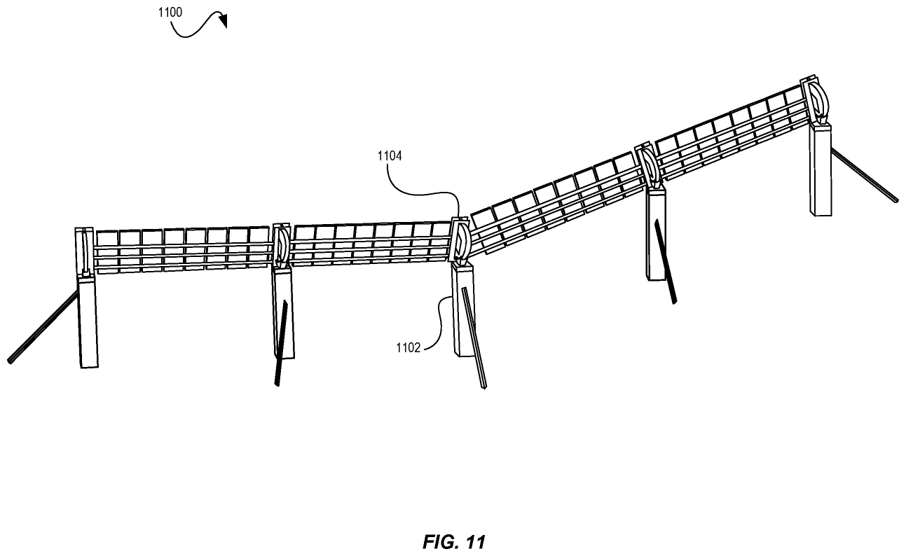

FIG. 11 illustrates a rear view 1100 of an example site deployment of a single axis tracker wire rope-based racking system in accordance with one or more embodiments. As shown in the example of FIG. 11, the change in grade occurs at foundation 1102, where the row begins to traverse uphill. So long as this change in grade is less than or equal to 35 degrees, no further changes are needed to the wire rope-based racking system to accommodate this change in direction. As shown, the wire ropes are coupled to the wire rope bracket in the same fashion as in the flat section of the row (e.g., using conventional wire rope connections). The flexibility of the ropes allows for the grade to be traversed as needed. If an overall grade of greater than 35 degrees needs to be traversed, then the path can be divided into sections of less than or equal to 35 degree grades. Each section will be bounded by foundations, ensuring that no given section has a grade of greater than 35 degrees.

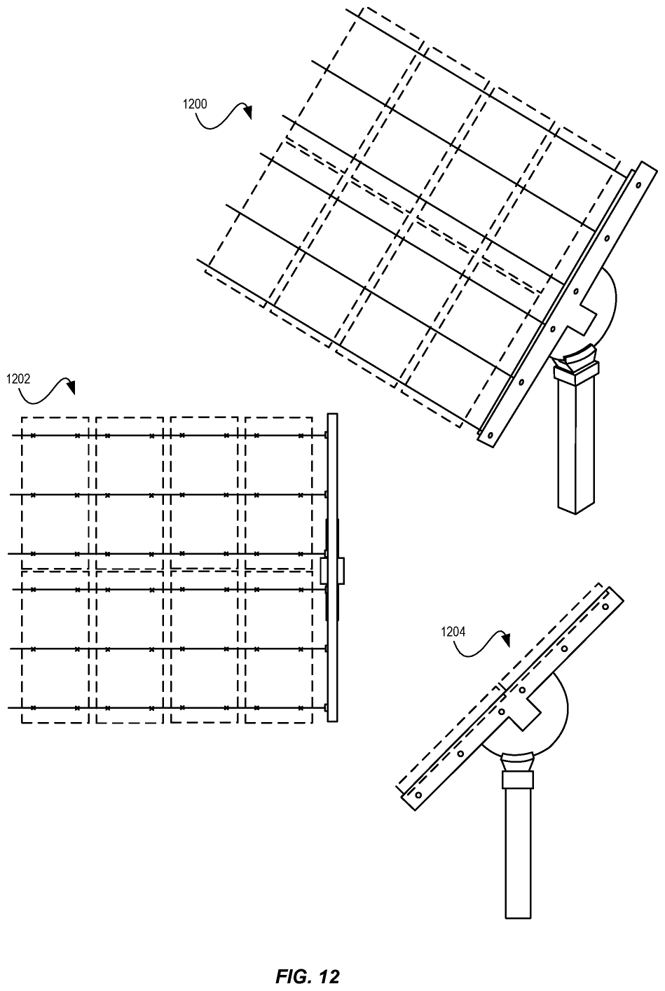

FIG. 12 illustrates additional views of a single axis tracker wire rope-based racking system in accordance with one or more embodiments. As shown in FIG. 12, an isometric view 1200, overhead view 1202, and side view 1204 of the wire rope-based racking system. As discussed, the wire rope-based racking system can support a plurality of panels by coupling the panels to a system of wire ropes. Although many of the examples described herein, depict the wire rope-based racking system as supporting a single row of panels, in some embodiments the wire rope-based racking system may support two rows, as depicted in FIG. 12.

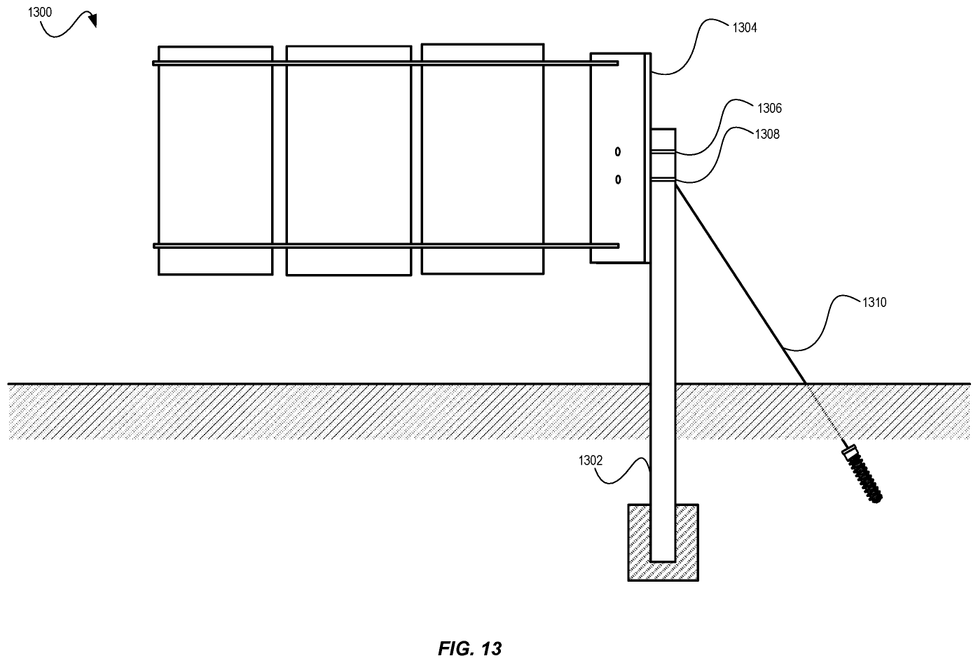

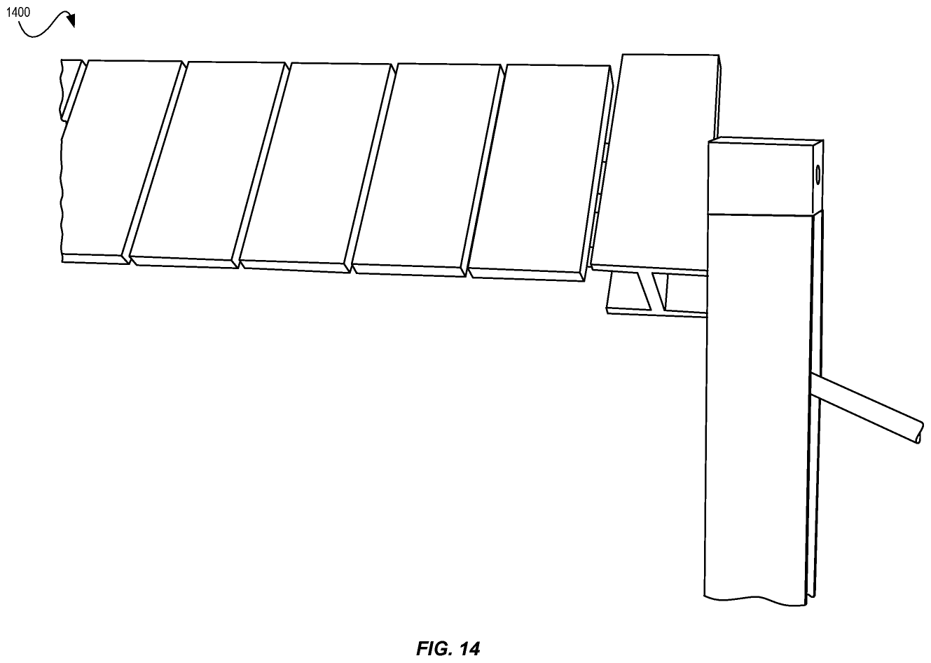

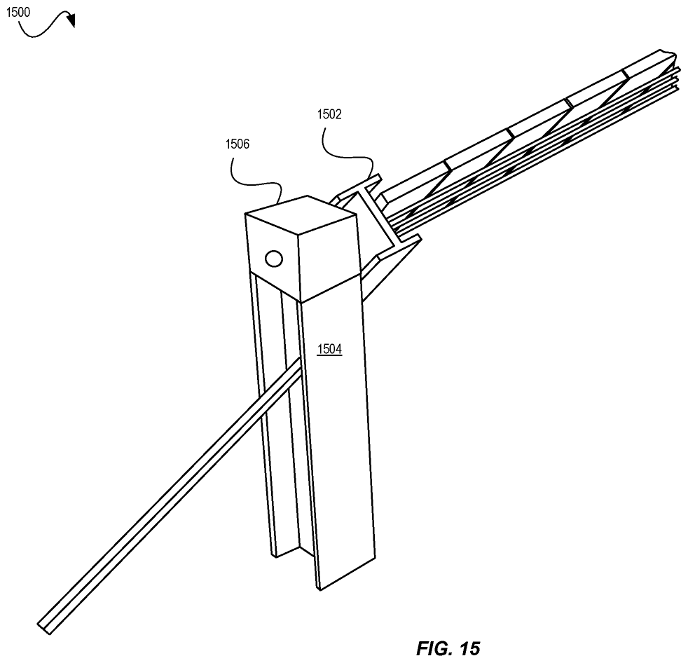

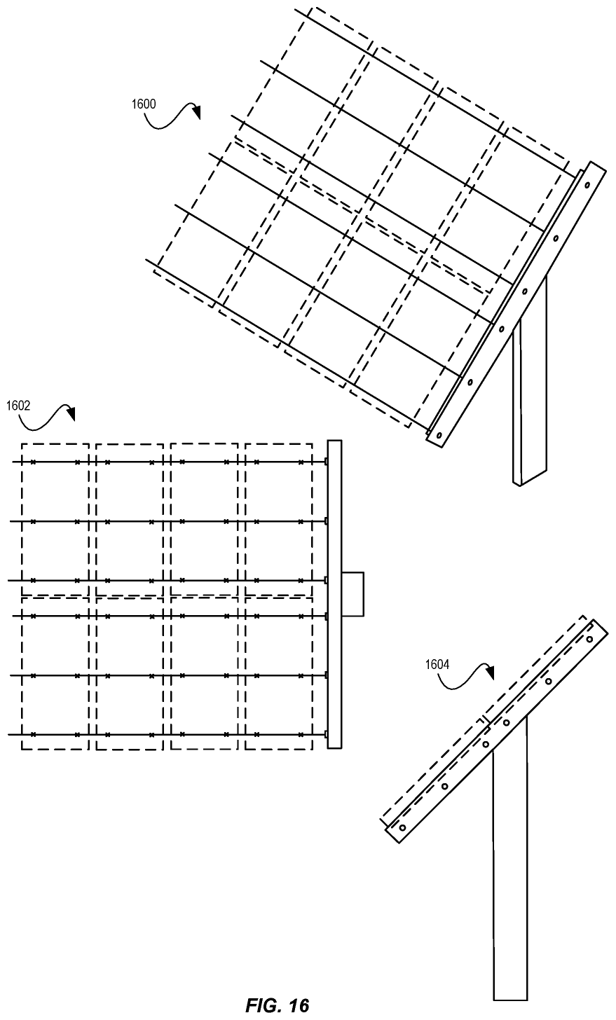

FIGS. 13-16 illustrate additional views of a fixed axis wire rope-based racking system in accordance with one or more embodiments. FIG. 13 illustrates a rear view 1300 of a fixed axis wire rope-based racking system installed on a site in accordance with one or more embodiments. Unlike the tracker systems described above, the wire rope-based racking system may also be implemented in fixed installations. In such embodiments, the wire rope-based racking system is coupled to the foundation 1302 at a fixed angle. For example, as shown in FIG. 13, the wire rope bracket 1304 of the wire rope-based racking system may be coupled to the foundation using bolts 1306, 1308 or via other fasteners or connection types. As in the tracking examples discussed above, the foundation may be stabilized using a guy wire and ground anchor 1310. FIG. 14 illustrates a front view 1400 of a similar installation. FIG. 15 shows an isometric view 1500 of the fixed wire rope-based racking system. As discussed, the wire rope bracket 1502 is coupled to a foundation 1504, either directly or via another bracket 1506. FIG. 16 illustrates an isometric view 1600, overhead view 1602, and side view 1604 of the wire rope-based racking system. As discussed, the wire rope-based racking system can support a plurality of panels by coupling the panels to a system of wire ropes. Like the tracking examples discussed above with respect to FIG. 12, the fixed racking systems may also support multiple rows of panels, as depicted in FIG. 16.

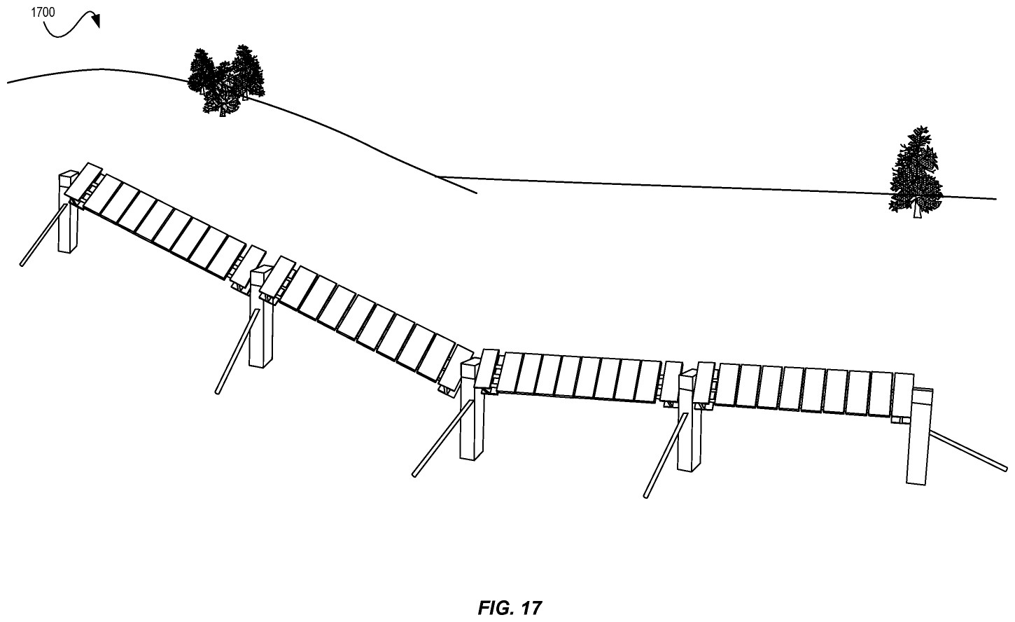

FIG. 17 illustrates an example site deployment 1700 of a fixed wire rope-based racking system in accordance with one or more embodiments. Similar to the tracker system described above, embodiments when implemented as a fixed angle installation may also be deployed over rough terrain. For example, as shown in FIG. 17, embodiments may likewise be installed with minimal site preparation. As in the example described with respect to FIG. 10, the maximum grade between a pair of foundations can be 35 degrees. This enables coverage over rough terrain with minimal site preparation.

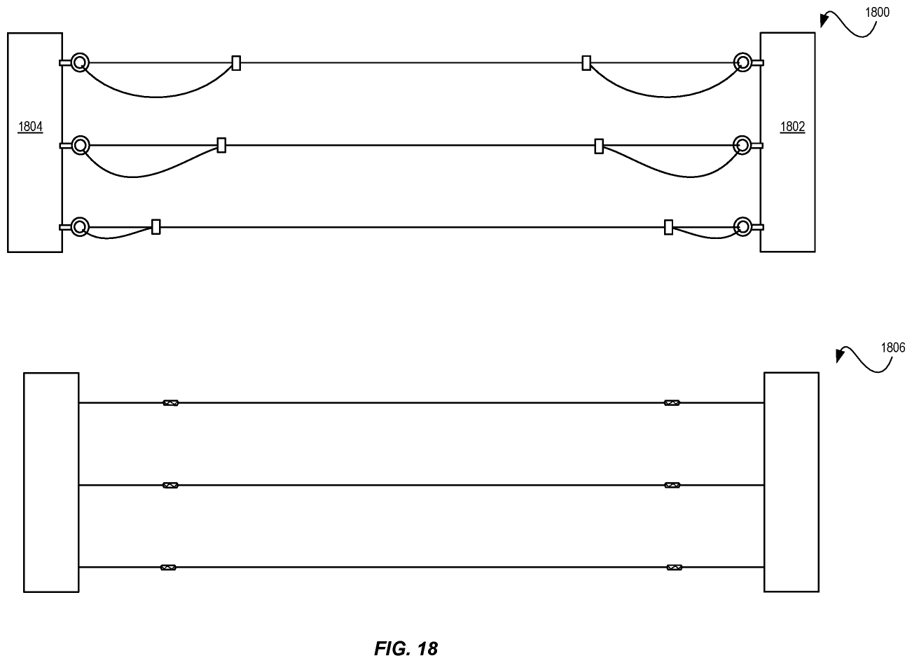

FIG. 18 illustrates examples of wire rope attachment systems in accordance with one or more embodiments. As discussed, each wire rope-based racking system includes a wire rope network that connects, at each end, to a wire rope bracket. The wire ropes may be connected to the wire rope brackets using known techniques. For example, as shown at 1800, each wire rope bracket 1802, 1804 includes eyebolts. The wire ropes are run through the eyebolts and adjusted to appropriate tension before being fastened using a clamp or clip, as shown in 1800, or a crimping sleeve, as shown in 1806, or other known fastener.

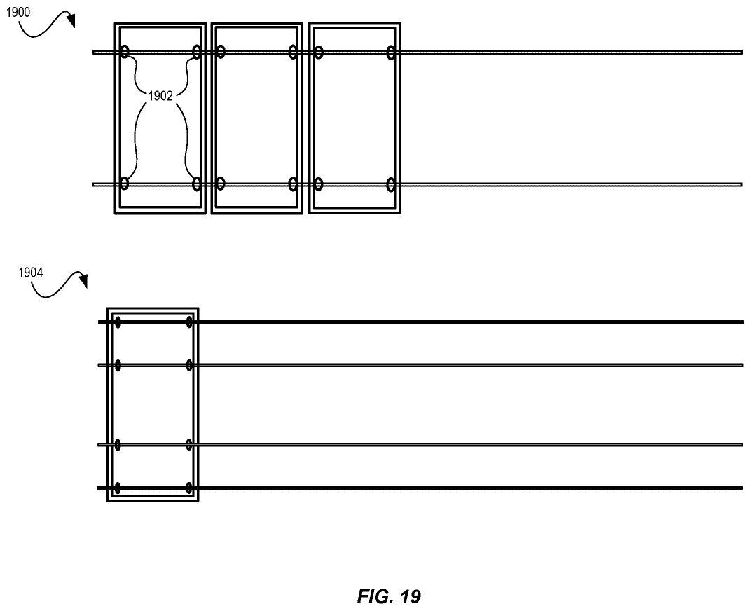

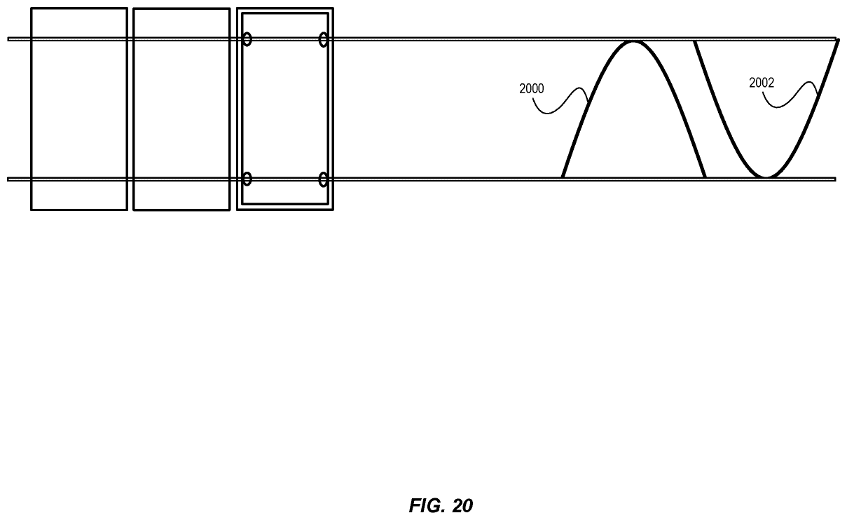

FIGS. 19-20 illustrate wire rope arrangements in accordance with one or more embodiments. As discussed, the number of wire ropes used in a given implementation may vary depending on installation needs. In the example shown at 1900, two wire ropes are used to support the panels. Each panel is coupled to the wire rope network using wire rope fasteners 1902 as are known in the art. For example, each panel may be connected using one or more fastener per wire rope. Likewise, the wire rope network may include more wire ropes, such as the four wire ropes shown at 1904. In some embodiments, a minimum number of wire ropes in a wire rope network is two. FIG. 20 shows an example of using cross cables 2000, 2002 in the wire rope network. As known in the art, such cross cables may be used to add additional structural support to the wire rope network.

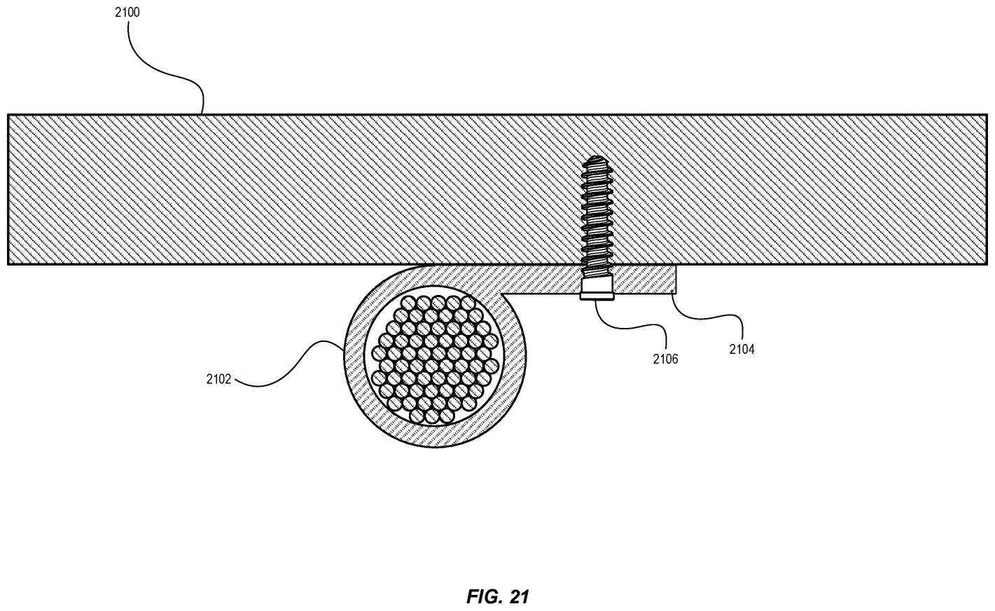

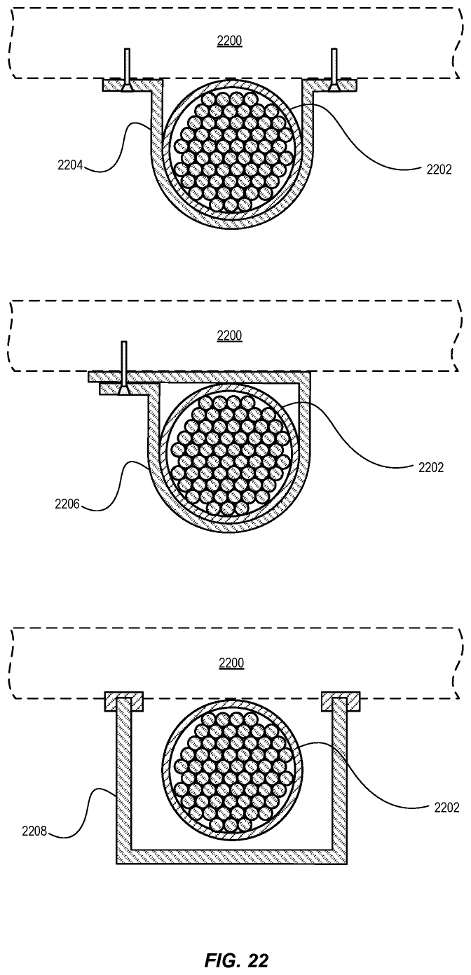

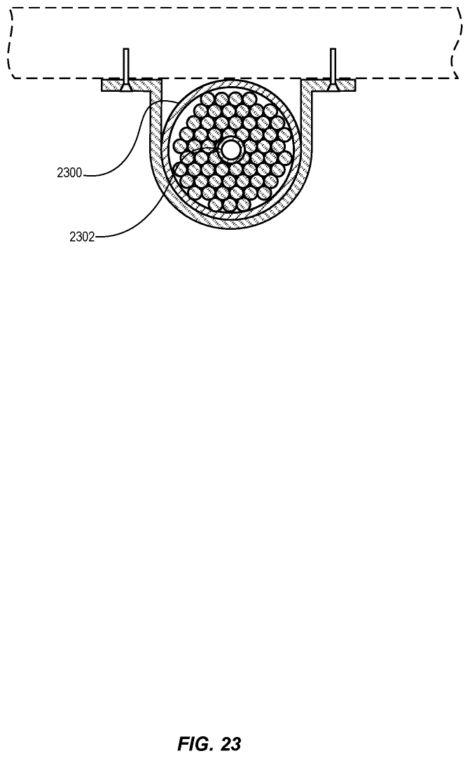

FIGS. 21-23 illustrate examples of wire rope-to-panel mounts in accordance with one or more embodiments. In the example of FIG. 21, the wire rope 2102 may include an integrated mounting panel 2104 which may be fastened to the panel 2100. For example, a portion of the panel may be drilled and tapped to enable a screw, bolt, or other fastener to connect the p-strap to the panel. FIG. 22 shows additional mounting options. As shown in FIG. 22, a panel 2200 may be connected to a wire rope 2102 via a u-strap 2204, a p-strap 2206, an integrated channel 2208, or similar mount. In some embodiments, any mount which compresses the wire rope as it is fastened into place on the panel may be used. As discussed, the wire rope used to form the wire rope network may include various types of wire rope, such as aircraft cable. In some embodiments, as shown in FIG. 23, the wire rope 2300 may be augmented with a transmission line 2302 which transfers electricity generated by the panels back to a substation or other destination.

Embodiments are generally described with respect to racking systems for photovoltaic panels (e.g., “solar” panels) for use in electricity generation. However, embodiments are equally applicable for supporting other panels in different installations. For example, solar thermal energy generation plants concentrate solar energy using mirrored panels (e.g., heliostats). These may likewise by mounted using wire rope racking systems described herein. Such embodiments would likewise benefit from reduced material requirements, less site preparation, etc.

Embodiments described herein may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

1. A panel racking system, comprising:
at least one panel;
a foundation including at least two posts; and
a wire rope network coupled to the foundation between the at least two posts, the wire rope network comprising a plurality of wire ropes structurally supporting the at least one panel, wherein the wire rope network lacks a rigid frame, and wherein the wire rope network contacts the at least one panel on a single planar face of the at least one panel.

2. The panel racking system of claim 1, wherein the wire rope network further comprises:
a first wire rope bracket, wherein a first end of the plurality of wire ropes is connected to the first wire rope bracket; and
a second wire rope bracket, wherein a second end of the plurality of wire ropes is connected to the second wire rope bracket;
wherein the first wire rope bracket is coupled to a first post of the foundation at a fixed angle and the second wire rope bracket is coupled to a second post of the foundation at the fixed angle.

3. The panel racking system of claim 1, wherein the wire rope network further comprises:
a first wire rope bracket, wherein a first end of the plurality of wire ropes is connected to the first wire rope bracket; and
a second wire rope bracket, wherein a second end of the plurality of wire ropes is connected to the second wire rope bracket;
wherein the first wire rope bracket is coupled to solar tracking mechanism, wherein the solar tracking mechanism is coupled to a first post of the foundation.

4. The panel racking system of claim 3, wherein the second wire rope bracket is coupled to a second solar tracking mechanism coupled to a second post of the foundation.

5. The panel racking system of claim 3, wherein the solar tracking mechanism is a single axis tracker.

6. The panel racking system of claim 1, wherein the at least one panel is coupled to each wire rope of the plurality of wire ropes using a wire rope strap.

7. The panel racking system of claim 1, wherein the posts of the foundation are buried.

8. The panel racking system of claim 1, wherein the foundation is ballasted.

9. The panel racking system of claim 1, wherein a slope between a first post of the foundation and a second post of the foundation does not exceed 35 degrees.

10. The panel racking system of claim 1, wherein the at least one panel is a photovoltaic panel.

11. The panel racking system of claim 1, wherein the wire rope network further includes one or more cross cables connecting the wire ropes to one another.

12. A panel racking system, comprising:
a wire rope-based racking system comprising a plurality of wire rope brackets coupled to one another using a plurality of parallel wire ropes;
a plurality of foundation posts, wherein each wire rope bracket is mounted to a foundation post; and
a plurality of panels, wherein each panel is coupled to the plurality of wire ropes using a plurality of wire rope-to-panel mounts, wherein a wire rope-to-panel mount of the plurality of wire rope-to-panel mounts contacts a panel of the plurality of panels on a single planar face of the panel.

13. The panel racking system of claim 12, wherein the plurality of panels includes at least one heliostat.

14. The panel racking system of claim 12, wherein the wire rope-to-panel mount is attached to a panel using a fastener, wherein as the fastener is tightened the wire rope-to-panel mount is compressed around the wire rope.

15. The panel racking system of claim 12, wherein a grade between a first foundation post and a second foundation post does not exceed+/−35 degrees.

16. A wire rope-based racking system, comprising:
a wire rope network including a plurality of wire ropes, the wire rope network supporting at least one panel that is mounted to the wire rope network, wherein the wire rope network contacts the at least one panel on a single planar face of the at least one panel;
a first wire rope bracket coupled to a first end of the wire rope network; and
a second wire rope bracket coupled to a second end of the wire rope network;
wherein the first wire rope bracket and the second wire rope bracket are coupled to a foundation.

17. The wire rope-based racking system of claim 16, wherein the first wire rope bracket and the second wire rope bracket are coupled to the foundation at a fixed angle.

18. 18. The wire rope-based racking system of claim 16, wherein the first wire rope bracket is coupled to the foundation via a first tracking mechanism and wherein the second wire rope bracket is coupled to the foundation via a second tracking mechanism.

19. The wire rope-based racking system of claim 16, wherein the foundation comprises a first post coupled to the first wire rope bracket and a second post coupled to the second wire rope bracket.

20. The wire rope-based racking system of claim 16, further comprising:
a plurality of panels, including the at least one panel, wherein the plurality of panels are mounted to, and supported by, the wire rope network.
